(19) United States
(12) Patent Application Publication
(10) Pub. No.: US 2026/0204282 A1
(43) Pub. Date: Jul. 16, 2026

(54) MAGNETIC RECORDING AND REPRODUCTION DEVICE AND ADJUSTMENT METHOD OF THE SAME

(71) Applicants: KABUSHIKI KAISHA TOSHIBA, Kawasaki-shi (JP); TOSHIBA ELECTRONIC DEVICES & STORAGE CORPORATION, Kawasaki-shi (JP)

(72) Inventors: Kaori KIMURA, Yokohama Kanagawa (JP); Takao FURUHASHI, Kawasaki Kanagawa (JP); Toru WATANABE, Kawasaki Kanagawa (JP)

(73) Assignees: KABUSHIKI KAISHA TOSHIBA, Kawasaki-shi (JP); TOSHIBA ELECTRONIC DEVICES & STORAGE CORPORATION, Kawasaki-shi (JP)

(21) Appl. No.: 19/359,130

(22) Filed: Oct. 15, 2025

(30) Foreign Application Priority Data
Jan. 15, 2025 (JP) 2025-005426

(51) Int. Cl. G11B 5/41; G11B 5/00

(52) U.S. Cl. CPC G11B 5/41; G11B 2005/0021

(57) ABSTRACT

According to one embodiment, a method of adjusting a heat-assisted magnetic recording and reproduction device including a heat-assisted magnetic recording head and a heat-assisted magnetic recording medium provided with a lubricant on a recording surface thereof, and the method includes operating the heat-assisted magnetic recording head on the recording surface, and measuring a build-up product generation 10 time until the lubricant fills between the recording surface and the heat-assisted magnetic recording head to generate a build-up product, and setting a cleaning time interval for cleaning the build-up product based on the build-up product generation time.

### CROSS-REFERENCE TO RELATED APPLICATIONS

This application is based upon and claims the benefit of priority from Japanese Patent Application No. 2025-005426, filed Jan. 15, 2025, the entire contents of which are incorporated herein by reference.

### FIELD

Embodiments described herein relate generally to a magnetic recording and reproduction device and an adjustment method of the same.

### BACKGROUND

In a heat-assisted magnetic recording head, the temperature of a magnetic disk is raised for recording by laser. It is known that, at this time, components considered to originate from a magnetic film of the magnetic disk adhere to a tip of a near-field optical element via the lubricant, and a hardened substance is generated. This hardened substance is called a build-up product.

Here, it is known that, when the hardened lubricant adheres, some materials of the adhering material can increase the transmittance of the laser, which can function as a layer for raising the laser transmission efficiency. If the flying height of the build-up product is lowered, it is worn away by abrasion, whereas if the flying height is raised, the build-up product is regenerated by the lubricant filling between the head and the medium.

The amount of build-up product generated may depend in some cases on the environment inside the magnetic recording and reproduction device and the ratio of silicon (Si), aluminum (Al), titanium (Ti), and tantalum (Ta)-based materials contained in the magnetic recording medium. Note here that silicon-based materials such as siloxanes can cause smearing (dirt) on the surface of the air bearing surface (ABS). For example, when a large amount of build-up product adheres to the head, there is a possibility that a head-disk interface (HDI) failure is caused, and therefore it is considered to be effective to periodically clean and regenerate the build-up product.

### BRIEF DESCRIPTION OF THE DRAWINGS

FIG. 1 is a block diagram illustrating a configuration example of a magnetic recording and reproduction device according to the second embodiment.

FIG. 2 is a partially exploded perspective view showing the magnetic recording and reproduction device according to the second embodiment.

FIG. 3 is a side view showing a magnetic recording medium, a magnetic head and a suspension.

FIG. 4 is a transverse cross-sectional view showing some parts of the magnetic recording and reproduction device according to the second embodiment.

FIG. 5 is a flow diagram illustrating a method for adjusting a magnetic recording and reproduction device according to the first embodiment.

FIG. 6 is a diagram of a graph illustrating a relationship between a time and a bit error rate measured at a certain time interval.

FIG. 7 is a model diagram showing a guard band as an inter-band area (band area) of an SMR of a non-data area.

FIG. 8 is a flowchart showing an example of a cleaning operation in a heat-assisted magnetic recording and reproduction device.

FIG. 9 is a block diagram showing an example of an MPU that can be used in the magnetic recording and reproduction device according to the second embodiment.

FIG. 10 is a block diagram showing another example of an MPU that can be used in a magnetic recording and reproduction device according to the second embodiment.

FIG. 11 is a diagram by graph showing a relationship between an operation time of the heat-assisted magnetic recording and reproduction device and the bit error rate.

FIG. 12 is a diagram by graph showing a relationship between the operating time of the heat-assisted magnetic recording and positioning data.

FIG. 13 is a diagram by graph showing a relationship between a bit error rate saturation time and an interval in a cleaning time.

### DETAILED DESCRIPTION

In general, according to one embodiment, a method for adjusting a heat-assisted magnetic recording and reproduction device which comprises a heat-assisted magnetic recording head and a heat-assisted magnetic recording medium provided with a lubricant on a recording surface thereof, is provided, and the method comprises operating the heat-assisted magnetic recording head on the recording surface, and measuring a build-up product generation time until the lubricant fills between the recording surface and the heat-assisted magnetic recording head to generate a build-up product, and setting a cleaning time interval for cleaning the build-up product based on the build-up product generation time.

Further, according to another embodiment, a heat-assisted magnetic recording and reproduction device comprises a heat-assisted magnetic recording head, a heat-assisted magnetic recording medium provided with a lubricant on a recording surface thereof, a build-up product cleaning controller which controls cleaning of a build-up product generated between the heat-assisted magnetic recording head and the recording surface, and a cleaning time interval controller which controls a cleaning time interval for the build-up product. The cleaning time interval is set based on a build-up product generation time, which is obtained by operating the heat-assisted magnetic recording head on the recording surface in advance and measuring the build-up product generation time until the build-up product is generated as the lubricant fills between the recording surface and the heat-assisted magnetic recording head.

According to the embodiment, the cleaning time interval is controlled for the build-up product generation of the heat-assisted magnetic recording head and thus the cleaning is performed periodically. Thereby, the size of the build-up product can be adjusted, and the occurrence of smear can be suppressed, thereby making it possible to obtain good recording performance. Further, according to the embodiments, by controlling the cleaning time interval, the size of the build-up product can be adjusted effectively with a minimum number of times of cleaning.

Embodiments will now be described with reference to the accompanying drawings.

The disclosure is merely an example and is not limited by contents described in the embodiments described below. Modification which is easily conceivable by a person of ordinary skill in the art comes within the scope of the disclosure as a matter of course. In order to make the description clearer, the sizes, shapes and the like of the respective parts may be changed and illustrated schematically in the drawings as compared with those in an accurate representation. Constituent elements corresponding to each other in a plurality of drawings are denoted by the same reference numerals and their detailed descriptions may be omitted unless necessary.

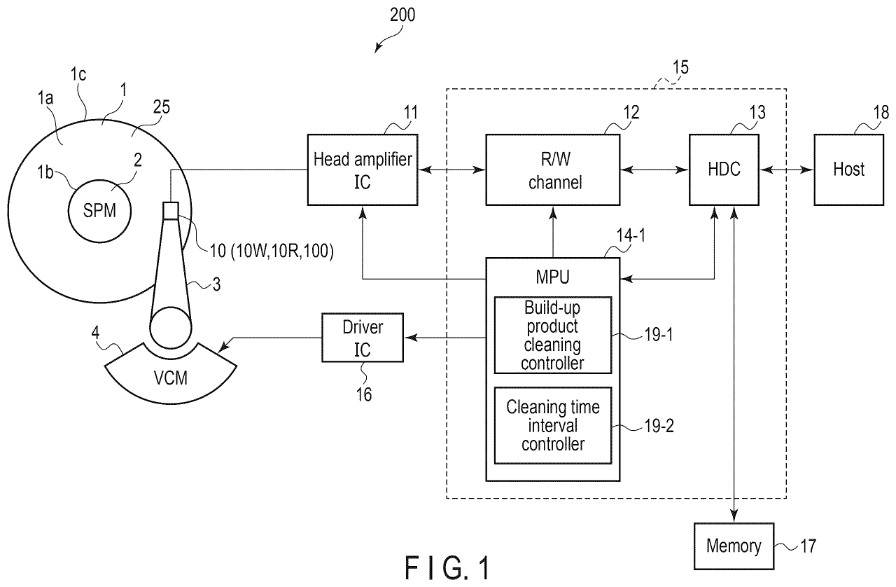

First, with reference to FIG. 1, the configuration of an example of a disk drive that can be applied to the second embodiment will be explained. Note that the configuration of the disk drive, which is a magnetic recording and reproduction device, shown in FIG. 1 is applicable to each of the embodiments described below as well.

The embodiments will now be described concretely by presenting examples.

First, with reference to FIG. 1, a configuration example of a disk drive according to the first embodiment will be explained. Note that the configuration of the disk drive, which is a magnetic recording and reproduction device, shown in FIG. 1 is also applicable to each of the embodiments to be described later.

As shown in FIG. 1, a disk drive 200 is a magnetic recording and reproduction device of a perpendicular magnetic recording scheme, incorporating a magnetic disk 1 that is a perpendicular magnetic recording medium and a magnetic head 10 including a magnetic flux control layer to be described later.

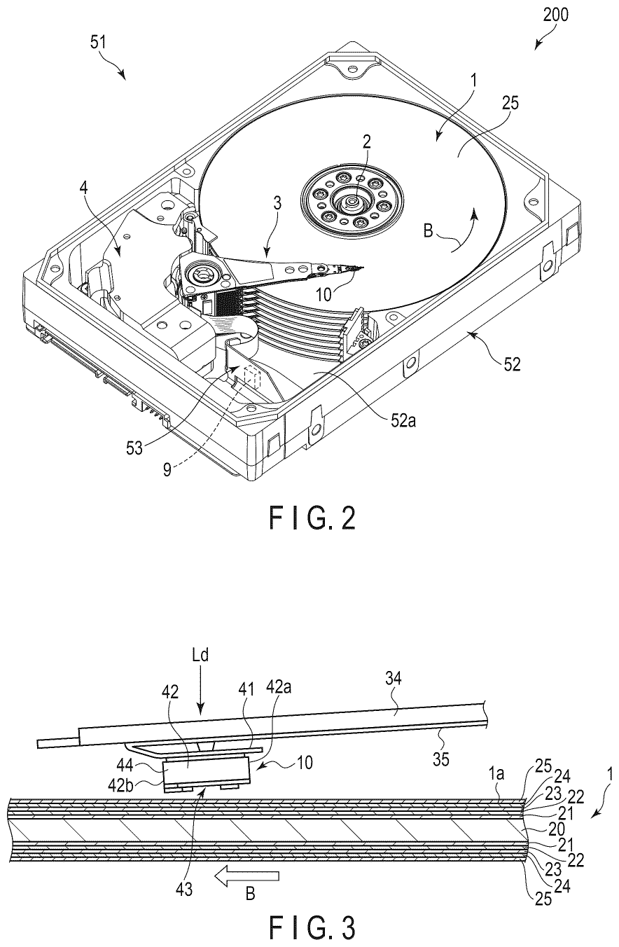

FIG. 2 is a partially exploded perspective view showing a magnetic recording and reproduction device.

FIG. 2 illustrates a state in which a plurality of magnetic disks 1 and a plurality of magnetic heads 10 are housed in a housing 51 in the magnetic recording and reproduction device, and a lid portion is omitted.

The disks 1 are fixed to a spindle motor (SPM) 2 and mounted to make rotational motion in a direction indicated by an arrow B. On the surface of each disk 1, a lubricant layer 25 is provided. The magnetic heads 10 are mounted on an actuator 3 and are configured to move in a radial direction above the disks 1. The actuator 3 is driven to rotate by a voice coil motor (VCM) 4. The magnetic head 10 comprises a write head 10W, a read head 10R, and a heat-assist unit 100. The write head 10W writes data to the magnetic disk 1 (write). The read head 10R reads data from the magnetic disk 1. The heat-assist unit 100 assists in writing data when the write head 10W writes data to the magnetic disk 1. The magnetic head 10 can include one or more magnetic heads.

Furthermore, the disk drive includes a head amplifier integrated circuit (hereinafter referred to as a head amplifier IC) 11, a read/write channel (R/W channel) 12, a hard disk controller (HDC) 13, a microprocessor (MPU) 14, a driver IC 16, and a memory 17. The R/W channel 12, the HDC 13, and the MPU 14 are incorporated into a controller 15, which consists of a single-chip integrated circuit.

The head amplifier IC 11 includes a circuit group for driving a laser diode for performing heat assist, as will be described later. Further, the head amplifier IC 11 includes a driver that supplies to the recording head 10W a recording signal (write current) corresponding to the write data supplied from the R/W channel 12. In addition, the head amplifier IC 11 also includes a read amplifier that amplifies the read signal output from the reproducing head 10R and transmits the read signal to the R/W channel 12.

The R/W channel 12 is a signal processing circuit of the read/write data. The HDC 13 constitutes an interface between the disk drive and a host 18, and executes transfer control of the read/write data.

The MPU 14 is a main write operation controller of the disk drive and executes servo control necessary for controlling read/write operations and positioning the magnetic head 10. Further, the MPU 14 includes a build-up product cleaning controller 19-1 that controls the cleaning of a build-up product formed between the heat-assisted magnetic recording head 10 and a recording surface 1a, and a cleaning time interval controller 19-2 that controls the interval of the cleaning time of the build-up product.

The memory 17 includes a buffer memory composed of DRAM, a flash memory and the like. It can as well include a system area region of a magnetic recording medium.

FIG. 3 is a side view showing the magnetic head 10 and a suspension.

As shown in FIG. 3, each magnetic head 10 is constituted as a flying head, and includes a slider 42 having a shape of a substantially rectangular parallelepiped and a recording and reproducing head unit 44 provided at an outflow end (trailing end) of the slider 42. The magnetic head 10 is secured to a gimbal spring 41 provided at an end portion of a suspension 34. A head load L toward the surface of the magnetic disk 1 is applied to each magnetic head 10 by the elasticity of the suspension 34. As shown in FIG. 2, each magnetic head 10 is connected to a head amplifier IC 11 and an HDC 13 via the suspension 34 and a wiring member (flexure) 35 fixed on the arm.

Next, the structure of the magnetic disk 1 and the magnetic head 10 will be described in detail.

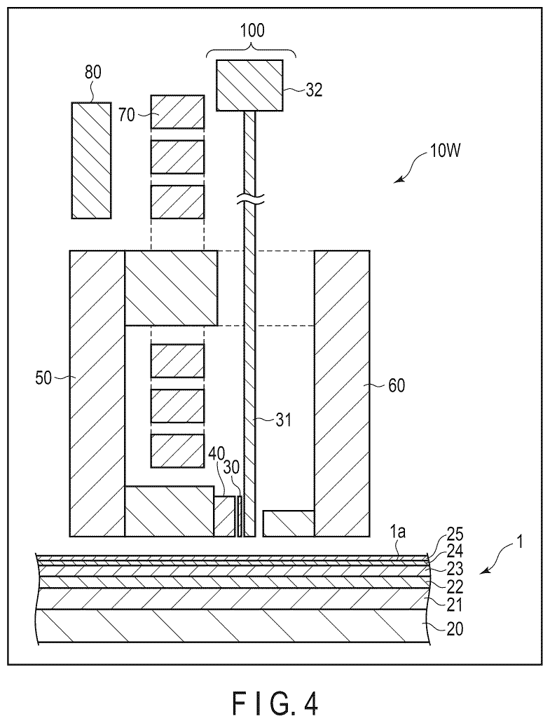

FIG. 4 is a transverse cross-sectional view showing the write head 10W and magnetic disk 1, which are parts of the magnetic recording and reproduction device.

The magnetic disk 1 includes a substrate 20, and a heat sink layer 21, a crystal orientation layer 22, a perpendicular recording layer 23, and a protective layer 24 and a lubricant layer 25 as a surface of the resultant by applying a lubricant, stacked in this order on the substrate 20. The perpendicular recording layer 23 has a large anisotropy perpendicular to the disk surface. The crystal orientation layer 22 is arranged under the perpendicular recording layer 23 to improve the orientation of that perpendicular recording layer 23. The heat sink layer 21 is arranged under the crystal orientation layer 22 to suppress the spread of the heating area. The protective layer 24 is arranged on an upper part of the perpendicular recording layer 23 to protect the perpendicular recording layer 23.

The magnetic head 10 is a separated magnetic head in which the recording head 10W and the reproducing head 10R are separated, and the recording head 10W is composed of a main magnetic pole 40 formed of a high permeability material that generates a magnetic field perpendicular to the disk surface, a trailing yoke 50 magnetically joined to the main magnetic pole that flows a magnetic flux to the main magnetic pole 40, a return shield magnetic pole 60 provided to efficiently close a magnetic path directly under the main magnetic pole, which is arranged on a leading side of the main magnetic pole 40, a coil 70 arranged to wrap around the magnetic path including the trailing yoke and the return shield magnetic pole to pass the magnetic flux to the main magnetic pole 40, a heater 80 for controlling the height of flying of the recording head, a near-field transducer 30 that generates near-field light to heat the perpendicular recording layer 23 of the magnetic recording media 1 on the leading side of the main magnetic pole 40, and a waveguide 31 that propagates the light for generating the near-field light. A light source is incorporated such that a laser diode 32 is mounted on a slider of the actuator assembly 3. The near-field transducer 30 can be formed of, for example, Au, Pd, Pt, Rh, or Ir, or an alloy consisting of a combination of some of these. An insulating layer between the main magnetic pole and the near-field transducer can be formed of, for example, an oxide of SiO₂, Al₂O₃, or the like.

Recording methods for heat-assisted magnetic recording that can be used in the magnetic recording and reproduction device 200 include so-called Conventional Magnetic Recording (CMR) for writing data in tracks at intervals in the radial direction and performing recording such that adjacent tracks do not overlap, so-called Shingled Magnetic Recording (SMR) including tracks stacked in order in the radial direction and recording over parts of the adjacent tracks, or so-called Interlaced Magnetic Recording (IMR) including a bottom track and a top track in which adjacent tracks are stacked alternately and, after recording on the bottom track, recording while stacking the bottom track on the interlaced top track, or a combination of these methods.

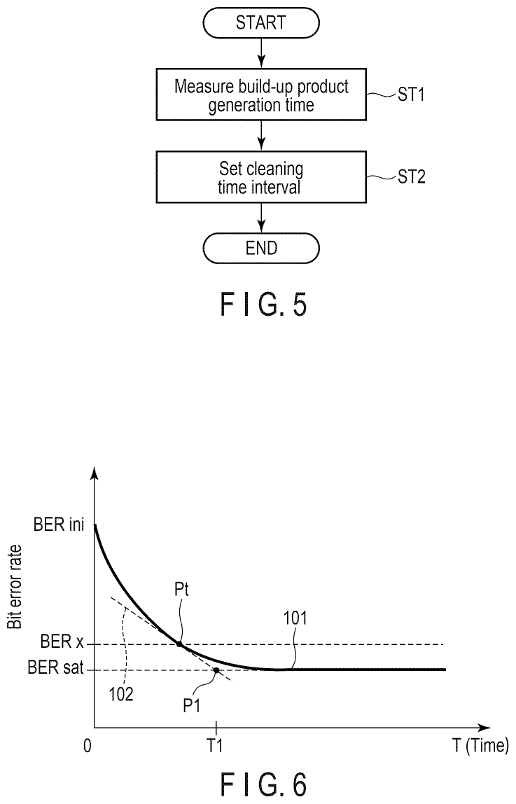

FIG. 5 is a flow diagram showing an adjustment method for a heat-assisted magnetic recording and reproduction device according to the first embodiment.

As shown in FIG. 5, in the adjustment method for the heat-assisted magnetic recording and reproduction device of the first embodiment, first, a heat-assisted magnetic recording head 10 is operated on a recording surface 1a to fill the lubricant between the recording surface 1a and the magnetic recording head 10, and a build-up product generation time until a build-up product is generated is measured (ST1). Next, based on the build-up product generation time, the interval of cleaning time for cleaning the build-up product is set (ST2).

### (Generation of Build-Up Product)

Generation of a build-up product can be carried out using the following method, for example. First, the head 10 is set to the flying height for writing, and a laser is applied from the laser diode 32 to generate near-field light by the near-field light element 30. Thus, while heating the magnetic recording medium 1, the write is conducted. At this time, the lubricant of the magnetic recording medium 1 is wound up and filled between the head 10 and the magnetic recording medium 1 to generate a build-up product. The generation of build-up product is carried out by taking a few milliseconds to a few hours depending on the laser and lubricant conditions, from the moment the laser is applied. The build-up product can be generated by applying a laser and heating the magnetic recording medium 1 to a high temperature. At this time, the write current is not necessarily required, and it can be generated by writing or seeking while the laser is being applied. Further, for generating the build-up product, a dedicated area can be provided inside the magnetic recording medium 1. Furthermore, the generation can be carried out in areas where the recording of information is not required, such as between the bands of the SMR. When heat is applied to the magnetic recording medium by the laser, if the temperature of the magnetic recording medium exceeds the Curie temperature, there is a risk that the recording pattern will disappear. Therefore, when the generation of a build-up product is performed in the data area, the area that is scheduled to be rewritten can be used, or the same pattern as that already recorded can be written.

### (Build-Up Product Generation Time)

In terms of build-up product generation time, there are some measuring methods, which include: a method of observing the head surface with an AFM or SEM and checking the size; a method of measuring the distance between the head and magnetic recording medium using an HDI sensor or the like; and a method of measuring the bit error rate of the heat-assisted magnetic recording and reproduction device.

For example, the build-up product generation time can be determined by periodically measuring the bit error rate of the heat-assisted magnetic recording and reproduction device and observing the change over time. Further, the build-up product generation time can be defined as the duration from the initiation of operation of the heat-assisted magnetic recording head to the point at which the temporal change in the bit error rate over time reaches a saturation level.

The measurement method using the bit error rate will now be described in more detail. With this method, it is possible to estimate the build-up product state without directly observing the head.

FIG. 6 is a diagram by graph showing the relationship between a time T and the bit error rate measured at regular intervals.

First, the head is cleaned, and then the writing is carried out under the setting of the specified recording density while fixing the write conditions at constant. Subsequently, when the bit error rate is measured at regular intervals, as shown by a BER curve 101, the bit error rate gradually decreases and the recording quality improves. During this time, the build-up product is generated on the head. When the build-up product is formed to have a certain size or larger, the value of the bit error rate saturates and no further change occurs. Here, the time at this saturated point P1 is defined as a build-up product generation time.

More specifically, in the BER curve 101 where the horizontal axis indicates the write time while the laser is on and the vertical axis indicates the bit error rate, the initial value of the bit error rate is referred to as BERini, the value at the point where the bit error rate no longer fluctuates is referred to as BERsat, the value that becomes (BERini-BERsat)×0.2+BERsat is referred to as BERx, and the point P1 of intersection between a tangent 102 of the BER curve 101 at BERx and the BERsat value is referred to as a point at which the bit error rate has saturated. Then, the time T1 at that point can be defined as a BER saturation time. Alternatively, when measuring the BERsat, for example, the moving average of the BER may be taken. The BER saturation time can be defined on the basis of the point at which the value changes or does not further improve at 5 points or more.

The measurement of the BER saturation time can be carried out during the HDD tuning process in the manufacturing process of the heat-assisted magnetic recording and reproduction device. The BER saturation time thus measured can be retained as a device parameter for each temperature zone and referred to when needed.

### (Cleaning of Build-Up Product)

The cleaning of the build-up product can be carried out using various cleaning methods. For example, one cleaning method is to lower the flying height of heat-assisted magnetic recording head with relative to the heat-assisted magnetic recording medium below the normal level, so as to wear away the build-up product. Or, it is possible as well to touchdown the heat-assisted magnetic recording head against the heat-assisted magnetic recording medium.

When the flying height of the head is to be lowered, it can be lowered to 0.5 nm and maintained for 1 second while the normal flying height setting value is 1 nm. The flying height can be lowered to various values, from the normal flying height to the point of contact, or even down to a few tens of angstroms. Generally, when the flying height is maintained at high level, the cleaning effect is weak, but when the flying height is lowered, there is a concern that the heat-assisted magnetic recording head and heat-assisted magnetic recording medium will wear out. Or, the touchdown, in which the heat-assisted magnetic recording head and the heat-assisted magnetic recording medium are brought into contact with each other, can be carried out once or multiple times.

Further, the cleaning can be carried out in the data area on the recording surface or the non-data area.

The cleaning itself does not generate heat and does not erase data, and therefore the cleaning can be carried out even in the data area. However, in order to avoid the risk of head contamination by abrasive particles that may be generated during cleaning, the cleaning may be carried out in the non-data area. For example, a dedicated area can be provided in the non-data area of an outermost circumference 1c or innermost circumference 1b of the recording surface 1a of the magnetic disk 1 shown in FIG. 1. Alternatively, a dedicated area for cleaning can be provided in an inter-band area of the shingled magnetic recording (SMR).

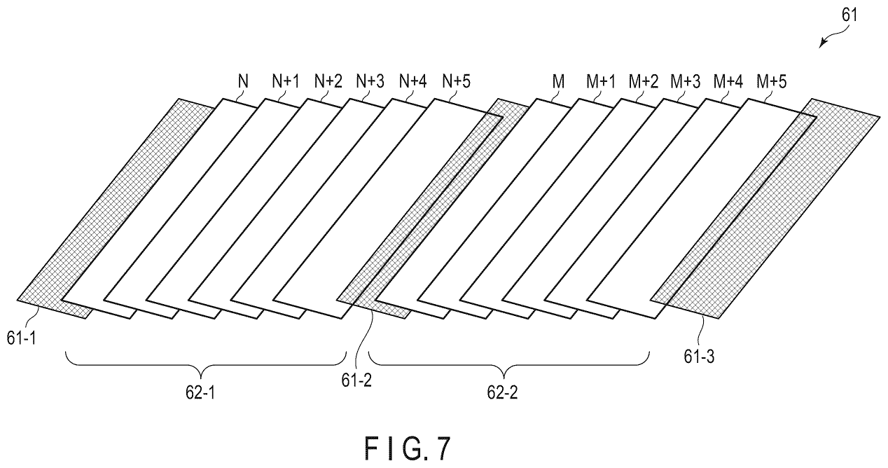

FIG. 7 is a model diagram showing a guard band as the inter-band area (band area) of the SMR in the non-data area.

As shown in the figure, between a band 62-1 of the shingled magnetic recording and another band 62-2 adjacent thereto, a guard band 61-2 is provided and shingled tracks N, N+1, N+2, N+3, N+4, and N+5 are provided in the band 62-1. In the guard band 61-2 and also in a band 62-2, shingled tracks M, M+1, M+2, M+3, M+4, and M+5 are provided. Note that the guard band 61-2 is slightly distant from the track N+5 and track M which are located on respective sides thereof, and it is not shingled thereon. On the opposite side of the guard band 61-2, the guard band 61-1 is provided via the band 62-1 of the shingled magnetic recording, and on the opposite side of the guard band 61-2 a guard band 61-3 is provided via the band 62-2 of the shingled magnetic recording. Here, in each case, the band is a little distant away from the tracks on the respective sides and is not shingled.

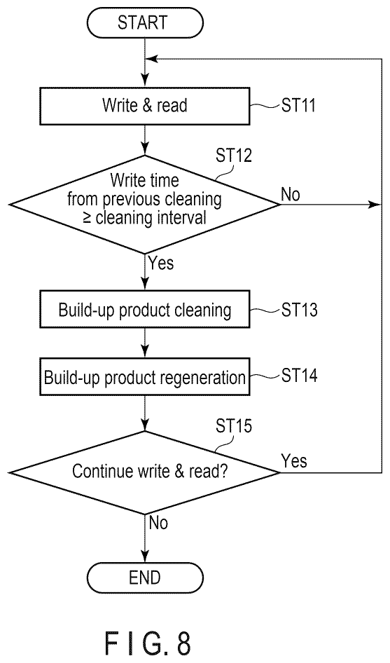

FIG. 8 is a flowchart showing an example of the cleaning operation in the heat-assisted magnetic recording and reproduction device.

First, upon receiving an instruction from the MPU 14, write and read are performed (ST11). Next, based on the information from the cleaning time interval controller 19-2, it is determined whether the write time after the start of the read/write operation or after the end of the previous cleaning is equal to or longer than a predetermined cleaning time interval (ST12). If it is no, the write and read are continued (ST11). If it is yes, build-up product cleaning is performed based on the information from the build-up product cleaning controller 19-1 (ST13), and then the write and read is continuously carried out, thereby regenerating the build-up product (ST14). After that, it is determined whether to continue the write and read (ST15). If yes, the write and read are continued (ST11), and if no, the write and read is terminated. Note that in step ST11, the operating time of the device can be utilized in place of the write time.

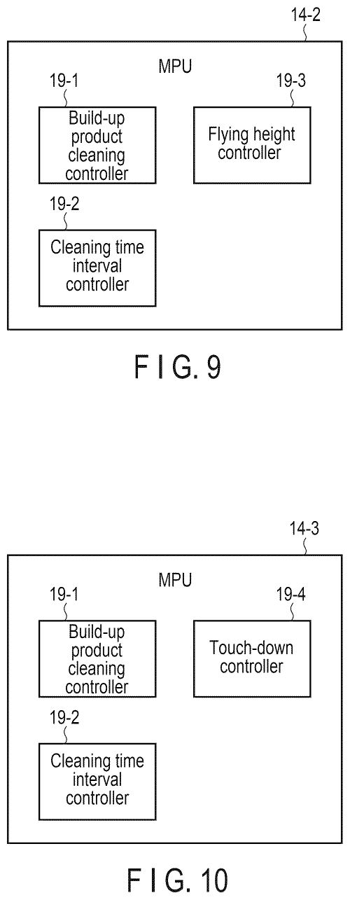

FIG. 9 is a block diagram showing an example of an MPU that can be used in a magnetic recording and reproduction device according to the second embodiment.

MPU shown in FIG. 9 is applicable to the magnetic recording and reproduction device of FIG. 1, and may have a configuration similar to that of FIG. 1 except that an MPU 14-2 is used in place of an MPU 14-1.

The MPU 14-2 has a configuration similar to that of the MPU 14-1 except that it further contains a flying height controller 19-3.

When the MPU 14-2 shown in FIG. 9 is applied to the configuration of FIG. 1, in the process of step ST14, for example, shown in FIG. 8, the flying height controller 19-3 can perform build-up product cleaning while lowering the flying height of the heat-assisted magnetic recording head 10 based on instructions from the build-up product cleaning controller 19-1.

FIG. 10 is a block diagram showing another example of the MPU that can be used in the magnetic recording and reproduction device of the second embodiment.

The MPU shown in FIG. 10 as well is applicable to the magnetic recording and reproduction device of FIG. 1, and may have a configuration similar to that of FIG. 1 except that an MPU 14-3 is used in place of the MPU 14-1.

The MPU 14-3 has a configuration similar to that of the MPU 14-1 except that it further contains a touchdown controller 19-4.

When the MPU 14-3 shown in FIG. 10 is applied to the configuration of FIG. 1, in the process of ST14, for example, in FIG. 8, the touchdown controller 19-4 can perform build-up product cleaning while touching down the heat-assisted magnetic recording head 10 on the recording surface 1a based on instructions from the build-up product cleaning controller 19-1.

### (Cleaning Time Interval for Build-Up Product)

The cleaning of a build-up product can be performed at a predetermined cleaning time interval based on the total write time or the operating time of the heat-assisted magnetic recording and reproduction device.

As time passes since a build-up product is generated, its size increases, which may affect, due to frictional force, head operations such as positioning and the like.

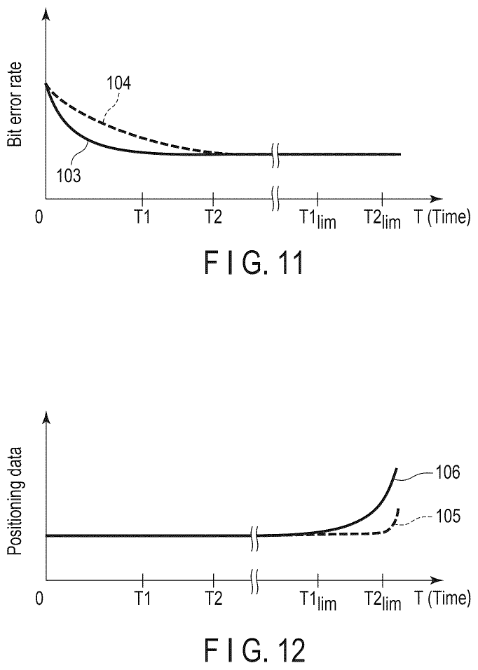

FIG. 11 is a diagram by graph showing the relationship between the write time when the laser of the heat-assisted magnetic recording and reproduction device is on and the bit error rate in the case where the build-up product generation time T is short and in the case where it is long.

A line 103 indicates the case where the build-up product generation time T is short, whereas a line 104 indicates the case where the build-up product generation time T is long. As indicated by the line 103, when the build-up product generation time T1 is short, the time T11im at which the bit error rate saturates is short as well.

FIG. 12 is a diagram by graph showing the relationship between the operating time of the heat-assisted magnetic recording and positioning data in the case where the build-up product generation time T is short and the case where it is long.

A line 106 indicates the case where the build-up product generation time T is short, whereas a line 105 indicates the case where the build-up product generation time T is long. As indicated by the line 106, when the build-up product generation time T1 is short, the time T11im at which deterioration in positioning starts to occur is short as well.

The T1im can be expressed by the following formula (A1) in relation to the build-up product generation time T.

$$Tlim = pT \times q , \qquad ( A1 )$$

where, in the formula, T1im represents the time at which positioning starts to deteriorate, and p and q are coefficients.

Here, the cleaning time interval L1 for a given head is determined from a value obtained based on the time T1im when positioning starts to deteriorate in consideration of the variation. For example, it is determined by a value obtained from, for example, the cleaning time interval L1=T1im×0.8.

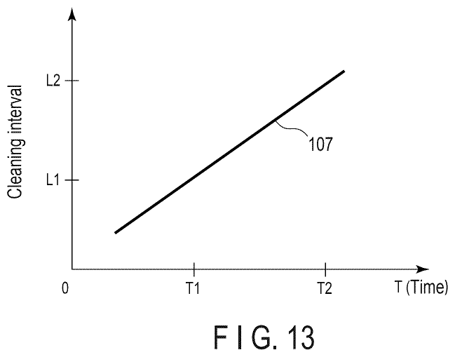

FIG. 13 is a diagram by graph illustrating the relationship between the bit error rate saturation time and the cleaning time interval.

From the relationship indicated by a line 107, it can be seen that the cleaning time interval L can be expressed using the build-up product generation time T by the following linear equation (1).

$$L = aT \times b , \qquad ( 1 )$$

where, in the formula, L represents the cleaning time interval, whereas T represents the build-up product generation time, and the coefficients a and b are calculated using the least squares method from multiple cleaning time intervals Lx and build-up product generation times Tx.

This cleaning time interval can be calculated in relation to the total time of the write or the operating time of the heat-assisted magnetic recording and reproduction device. For example, as in the cases shown in FIGS. 11 and 12, the time interval can be set based on the operating time of the heat-assisted magnetic recording and reproduction device, that is, the operating time when the power of the heat-assisted magnetic recording and reproduction device is on. In that case, the running time is recorded in the workload. Further, the total write time is recorded and the calculation can be made based on that time. In this case, such a procedure can be taken that each head has a different total write time, and the total write time is checked at regular intervals, and subsequently, the cleaning is performed starting with those that exceed the criteria.

Examples will now be given to explain the embodiments in more detail.

### Example 1

Sixty units of heat-assisted magnetic recording and reproduction devices were prepared, each equipped with a heat-assisted magnetic recording head and a heat-assisted magnetic recording medium. Forty of these devices were subjected to build-up product cleaning according to the BER saturation time, and the remaining twenty were subjected to build-up product cleaning at a fixed time. Then, each device was run for 1,000 hours. During the running, the total write time was checked once per hour. The build-up product cleaning was carried out using two methods. As a method 1-1, the flying height was fixed at 0.3 nm and held for 50 milliseconds, whereas as a method 1-2, touch-downs were carried out five times in succession.

The servo positioning data was measured before and after each test, and the devices having a head in which the non-repeatable run-out (NRRO) exceeded 5 nm were judged as no good (NG). The number of NG before the test was 0 for both conditions (methods). The number of NGs after each test is presented in Table 1 below.

TABLE 1

| | Build-up | Cleaning | NG rate |
|---|---|---|---|
| | product | time | after |
| | cleaning | interval | testing |
| Example | At 0.3 nm | BER | 0/20 units |
| 1-1 | and held | saturation | |
| | for 50 ms | time | |
| Example | Touchdown × | BER | 0/20 units |
| 1-2 | 5 times | saturation | |
| | | time | |
| Comparative | At 0.3 nm | Fixed time | 2/20 units |
| example | and held | | |
| | for 50 ms | | |

In Example 1, the number of NG was 0, but in the devices that were cleaned for a fixed time as a comparison, the number of NG was 2.

After the evaluation, the devices were disassembled and in each, the area around the head was examined by AFM observation. As a result, it was found that, around the heads evaluated as NG, the lubricant coagulated and hardened to form excessive build-up product, which interfered with the heads from operating smoothly.

### Example 2

As in Example 1, fifty units of heat-assisted magnetic recording and reproduction devices each equipped with a heat-assisted magnetic recording head and a heat-assisted magnetic recording media were prepared.

Table 2 below shows parameters for the calculation of the head cleaning method, cleaning area, and cleaning time interval, as to whether to use the total write time or the operating time of the heat-assisted magnetic recording and reproduction device. The example was further categorized into Examples 2-1, 2-2, 2-3, 2-4 and 2-5, in each of which, ten units were run for 1,000 hours. During the running, the total write time was checked once an hour. They were tested by two methods.

In Examples 2-1, 2-2, and 2-3, the build-up product cleaning was performed by a method in which the flying height was fixed at 0.1 nm and held for 50 milliseconds. In Examples 2-4 and 2-5, the build-up product cleaning was performed by another method in which the touchdown was performed ten times in succession.

The cleaning area was set to the dedicated outermost circumferential area in Example 2-1, the dedicated innermost circumferential area in Examples 2-2 and 2-5, the data area in Example 2-3, and the SMR band in Example 2-4.

The cleaning time interval was calculated based on the write time accumulation.

As in the case of Example 1, the positioning data of the servo was measured before and after the test. In the evaluation, the units having a head in which a non-repeatable run-out (NRRO) exceeded 5 nm were judged as NG, whereas the units having no such a head that an NRRO was 4 nm or more were judged as double circle (excellent), and the units having no such a head that an NRRO was 5 nm or more was judged as circle (good). The number of NG before the test was 0 for both conditions (methods). The results of the evaluation after the test in each case is shown in Table 2 below.

TABLE 2

| | | | Cleaning | |
|---|---|---|---|---|
| | | | time | |
| | Head | | interval | Evaluation |
| | cleaning | Cleaning | calculation | of head |
| | method | area | method | positioning |
| Example | At 0.1 nm | Dedicated | Write time | ⊚ |
| 2-1 | and held | outermost | | |
| | for 50 ms | circumferential | | |
| | | area | | |
| Example | At 0.1 nm | Dedicated | Write time | ⊚ |
| 2-2 | and held | innermost | | |
| | for 50 ms | circumferential | | |
| | | area | | |
| Example | At 0.1 nm | Data area | Write time | ◯ |
| 2-3 | and held | | | |
| | for 50 ms | | | |
| Example | Touchdown × | Between | Write time | ⊚ |
| 2-4 | 10 times | SMR bands | | |
| Example | Touchdown × | Dedicated | Operating | ⊚ |
| 2-5 | 10 times | innermost | time | |
| | | circumferential | | |
| | | area | | |

As presented by Examples 1 and 2, when the cleaning is performed periodically by controlling the cleaning time interval according to the embodiments, a good recording performance can be obtained. In addition, for the heat-assisted magnetic recording and reproduction devices that were not evaluated as NG, the size of the build-up product could be adjusted, and thus it is considered the occurrence of smear could be suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of adjusting a heat-assisted magnetic recording and reproduction device comprising a heat-assisted magnetic recording head and a heat-assisted magnetic recording medium provided with a lubricant on a recording surface thereof, the method comprising:
operating the heat-assisted magnetic recording head on the recording surface, and measuring a build-up product generation time until the lubricant fills between the recording surface and the heat-assisted magnetic recording head; and
setting a cleaning time interval for cleaning the build-up product based on the build-up product generation time.

2. The method of claim 1, wherein
the build-up product generation time is determined by periodically measuring the bit error rate of the heat-assisted magnetic recording and reproduction device, and is defined as the duration from the initiation of operation of the heat-assisted magnetic recording head to the point at which the temporal change in the bit error rate reaches a saturation level.

3. The method of claim 1, wherein
the cleaning time interval is calculated based on a total write time.

4. The method of claim 1, wherein
the cleaning time interval is calculated based on an operating time of the heat-assisted magnetic recording and reproduction device.

5. The method of claim 1, wherein
the cleaning time interval is expressed by a formula (1) below:
$$L = aT \times b \qquad ( 1 )$$
where a and b are coefficients, L represents cleaning time intervals, and T represents build-up generation time.

6. The method of claim 1, wherein
the cleaning includes lowering a flying height of the heat-assisted magnetic recording head with respect to the heat-assisted magnetic recording medium.

7. The method of claim 1, wherein
the cleaning includes touching down of the heat-assisted magnetic recording head with respect to the heat-assisted magnetic recording medium.

8. The method of claim 1, wherein
the cleaning is performed in a dedicated area provided in an innermost or outermost circumferential non-data area of the recording surface.

9. The method of claim 1, wherein
the cleaning is performed in a data area.

10. The method of claim 1, wherein
the cleaning is performed in a non-data area between bands of a shingled magnetic recording mode.

11. A heat-assisted magnetic recording and reproduction device comprising:
a heat-assisted magnetic recording head;
a heat-assisted magnetic recording medium provided with a lubricant on a recording surface thereof;
a build-up product cleaning controller which controls cleaning of a build-up product generated between the heat-assisted magnetic recording head and the recording surface; and
a cleaning time interval controller which controls a cleaning time interval for the build-up product, and
wherein the cleaning time interval is set based on a build-up product generation time, which is obtained by operating the heat-assisted magnetic recording head on the recording surface and measuring the build-up product generation time until the lubricant fills between the recording surface and the heat-assisted magnetic recording head.

12. The device of claim 11, wherein
the build-up product generation time is determined by periodically measuring the bit error rate of the heat-assisted magnetic recording and reproduction device, and is defined as the duration from the initiation of operation of the heat-assisted magnetic recording head to the point at which the temporal change in the bit error rate reaches a saturation level.

13. The device of claim 11, wherein
the cleaning time interval is calculated based on a total write time.

14. The device of claim 11, wherein
the cleaning time interval is calculated based on an operating time of the heat-assisted magnetic recording and reproduction device.

15. The device of claim 11, wherein
the cleaning time interval is expressed by a formula (1) below:
$$L = aT \times b \qquad ( 1 )$$
where a and b are coefficients, L represents cleaning time intervals, and T represents build-up generation time.

16. The device of claim 11, wherein
the build-up product cleaning controller controls the heat-assisted magnetic recording head to lower a flying height of the heat-assisted magnetic recording head with respect to the heat-assisted magnetic recording medium and performs the cleaning.

17. The device of claim 11, wherein
the build-up product cleaning controller performs the cleaning by touching down the heat-assisted magnetic recording head with respect to the heat-assisted magnetic recording medium.

18. The device of claim 11, wherein
the build-up product cleaning controller performs the cleaning in a dedicated area provided in an innermost circumferential or outermost circumferential non-data area of the recording surface.

19. The device of claim 11, wherein
the build-up product cleaning controller controls the heat-assisted magnetic recording head to perform the cleaning in a data area.

20. The device of claim 11, wherein
the build-up product cleaning controller performs the cleaning in the non-data area between bands of a shingled magnetic recording mode.
